(19) United States
(12) Patent Application Publication
(10) Pub. No.: US 2014/0023279 A1
(43) Pub. Date: Jan. 23, 2014

(54) Real Time Detecting and Tracing Apparatus and Method

(71) Applicant: National Taiwan University of Science and Technology, (US)

(72) Inventors: CHIN-SHYURNG FAHN, Taipei (TW); YU-SHU YEH, Taipei (TW)

(73) Assignee: National Taiwan University of Science and Technology, Taipei (TW)

(21) Appl. No.: 13/743,449

(22) Filed: Jan. 17, 2013

(30) Foreign Application Priority Data
Jul. 17, 2012 (TW) 101125659

(51) Int. Cl. G06K 9/62

(52) U.S. Cl. CPC G06K 9/6296
USPC 382/195

(57) ABSTRACT

A real time detecting and tracing apparatus comprises an image accessing module, an image preprocessing module, an image pyramids generation module, a detecting module, a tracing module, and a moving module. The image accessing module accesses an environmental image. The image preprocessing module shrinks the size of the environmental image and outputs a shrunken image. The image pyramids generation module generates an image pyramid according to the shrunken image. The detecting module scans the levels of the image pyramid and performs a sorting operation so as to position an object in the environmental image. The tracing module generates a tracing information according to the object information from the detecting module. The moving module traces or removes the object according the tracing information.

### BACKGROUND OF THE INVENTION

(1) Field of the Invention

The present invention relates to a real time detecting and tracing apparatus and method, particularly for one by means of computer vision to detect and trace objects in real time manner.

(2) Description of the Prior Art

To detect pedestrian passing by is always a critical issue of the computer vision, and stationary cameras with static background are popularly used in current supervisory control system of computer vision. However, such supervisory control system can not perform real time detecting and tracing function on a moving object of pedestrian or vehicle though it can judge whether any pedestrian or vehicle passing by so that it is not applicable to mobile apparatus or mobile robot such as floor-sweeping robot or ball-collecting robot etc., which require to perform real time detecting and tracing function on a moving object.

Certain computer-aided radar or infrared rays (IR) might be able to detecting and tracing surrounding object but it is unfavorable in performing real time detecting and tracing process because it takes a lot of time proceed operation and establish operational environment.

Moreover, by means of global positioning system (GPS) incorporating with suitable algorithm might also be able to detecting and tracing surrounding object but it is unable in performing real time detecting and tracing process in household environment or pedestrian indoor because it needs a global positioning system (GPS) operational environment.

### SUMMARY OF THE INVENTION

Having realized foregoing issues, the primary object is to provide a real time detecting and tracing apparatus using computer vision and method thereof for benefit to trace or bypass the objects.

The present invention is to provide a real time detecting and tracing apparatus using computer vision for quickly detecting and tracing an object in real time manner. The apparatus comprises an image accessing module, an image preprocessing module, an image pyramids generation module, a detecting module and a tracing module. The image accessing module accesses and acquires an environmental image to be processed and judged. The image preprocessing module removes unnecessary information from the image previously acquired to generate a processed images. The image pyramids generation module generates an image pyramid with plural component layers according to previously processed image. The detecting module scans all the component layers of the image pyramid in accordance with a feature information of a target object to perform a sorting operation to generate real time information for the target object. And the tracing module generates a tracing information according to the previously yielded real time information.

The present invention is to provide a real time detecting and tracing system using computer vision for quickly detecting and tracing an object in real time manner. The system comprises an image accessing module, an image preprocessing module, an image pyramids generation module, a training module, a detecting module and a tracing module. The image accessing module accesses and acquires an environmental image to be processed and judged. The image preprocessing module removes unnecessary information from the image previously acquired to generate a processed images. The image pyramids generation module generates an image pyramid according to previously processed image. The training module creates a feature information for a target object in accordance with plural training samples. The detecting module scans all the component layers of the image pyramid in accordance with the feature information of a target object and performs a sorting operation to generate real time information for the target object. And the tracing module generates a tracing information according to the previously yielded real time information.

The present invention is to provide a real time detecting and tracing method using computer vision for quickly detecting and tracing an object in real time manner. The method comprises following steps: (a) accessing and acquiring an environmental image to be processed and judged; (b) removing unnecessary information from the image previously acquired to generate a processed images; (c) generating an image pyramid according to previously processed image; (d) scanning all the component layers of the image pyramid in accordance with a feature information of a target object to perform a sorting operation to generate real time information for the target object; and (e) generating a tracing information according to the previously yielded real time information if there is the target object in the image to be judged.

The other objects and features of the present invention can be further understood from the disclosure in the specification.

### BRIEF DESCRIPTION OF THE DRAWINGS

FIG. 1 is a schematic view of block diagram showing a preferred exemplary embodiment for the real time detecting and tracing system using computer vision of the present invention.

FIGS. 2A and 2B are schematic views showing a wavelet transform on a processed image to be judged by the real time detecting and tracing system using computer vision in FIG. 1 of the present invention.

FIG. 3 is a schematic view showing a generated image pyramid after an image processing by the real time detecting and tracing system using computer vision in FIG. 1 of the present invention.

FIG. 4 is a schematic view showing scanning operation and sorting operation on all levels of the image pyramid generated previously by the real time detecting and tracing system using computer vision in FIG. 1 of the present invention.

FIG. 5 is a schematic view showing training algorithm of sorting operation on all component levels of the image pyramid generated previously to produce object feature by the real time detecting and tracing system using computer vision in FIG. 1 of the present invention.

FIG. 6 is a schematic view of flowchart showing a preferred exemplary embodiment for the real time detecting and tracing system using computer vision in FIG. 1 of the present invention.

FIG. 7 is a schematic view of flowchart showing the other preferred exemplary embodiment for the real time detecting and tracing system using computer vision in FIG. 1 of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

The technology of the present invention can be applied to automatic dwarf mobile robots such as ball-collecting robot, pet-mimic robot and floor-sweeping robot etc. with detailed performance as following. For ball-collecting robot, it can detect and trace ball-player movement to avoid colliding and interfering with the ball-player so that both of the ball-player and ball-collecting robot can simultaneously act its/his task respectively without mutual interference each other. For pet-mimic robot, it can detect and trace owner movement to interact with owner. For floor-sweeping robot, it can detect and trace floor-sweeper movement to avoid colliding and interfering with the ball-player so that both of the floor-sweeper and floor-sweeping robot can simultaneously act its/his task respectively without mutual interference each other. Therefore, the technology of the present invention allows automatic mobile robots perform real time detecting and tracing function on surrounding objects to take suitably corresponding measures such as ducking or continuously tracking.

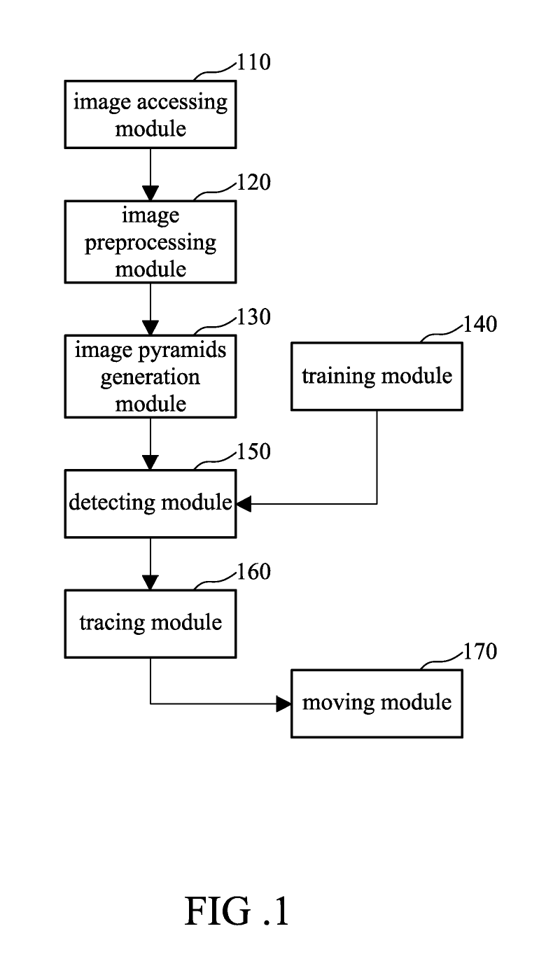

FIG. 1 is a schematic view of block diagram showing a preferred exemplary embodiment for the real time detecting and tracing system using computer vision of the present invention. As shown in FIG. 1, the system comprises an image accessing module (110), an image preprocessing module (120), an image pyramids generation module (130), a training module (140), a detecting module (150), a tracing module (160) and a moving module (170).

The image accessing module (110) continuously accesses and acquires a series of environmental images to be processed so that the system can judge whether a target object is detected according to these environmental images. For example, the image accessing module (110) is a single camera for providing a series of environmental images. Normally, a single camera with 320×240 resolutions for two-dimensional planar image instead of plural cameras for three-dimensional stereoscopic image is applicable for the image accessing module (110) of the present invention.

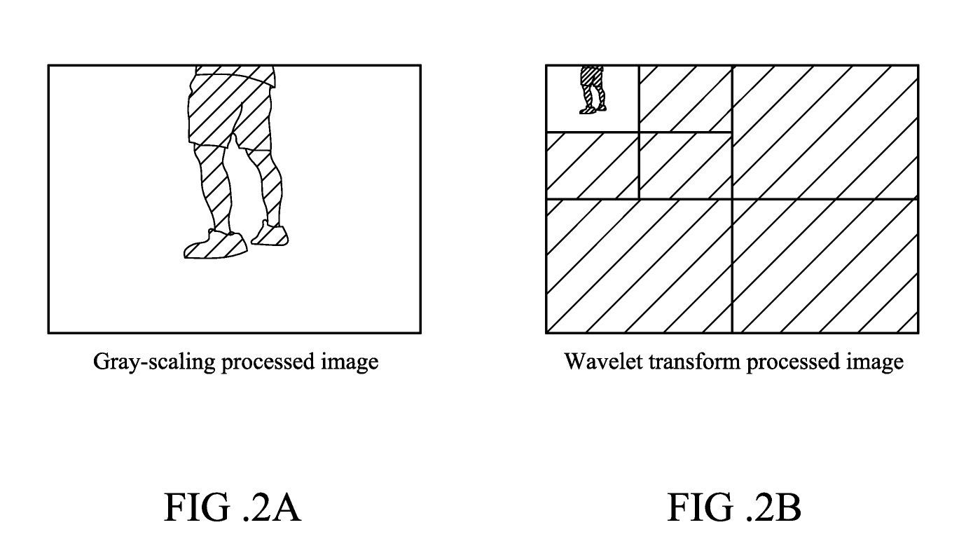

The image preprocessing module (120) removes unnecessary information from one of the series of environmental images acquired in previous image accessing module (110) to generate a processed images. In a preferred exemplary embodiment of the present invention, the processes in the image preprocessing module (120) include an image gray-scaling process and a Haar wavelet transform process, wherein the image gray-scaling process functions to convert original color images into colorless images, namely monochromatic images; and the Haar wavelet transform process functions to reduce the resolutions of the original images. FIGS. 2A and 2B are schematic views showing a wavelet transform on an image gray-scaling processed image to be judged by the real time detecting and tracing system using computer vision in FIG. 1 of the present invention. The image shown in FIG. 2A) is an image gray-scaling processed image before Haar wavelet transform process while the image shown in FIG. 2B is an image after image gray-scaling process and Haar wavelet transform process. The purposes of the image gray-scaling process and Haar wavelet transform process are to reduce overall quantity of the image information but still remain adequate feature information or feature information of the target object for recognition. For example, a object with feature in specific color is not suitably performed by an image gray-scaling process because its color feature information should be kept for object recognition while a large profiled object with feature in specific shape is suitably performed by a Haar wavelet transform process because its shape feature information is good enough for object recognition even its resolution is reduced so that both previous cases remain adequate feature information of the target object for recognition. Taking legs of a pedestrian in FIGS. 2A and 2B as an example, the legs are a pair of large profiled objects with feature in specific shapes without feature in specific color due to being highlighted by the knee breeches and shoes so that they are suitably performed by an image gray-scaling process and an adequate Haar wavelet transform process, which incur no harmful effect on the detecting result but can expedite process speed to achieve real time detecting purpose in consequence of the reducing overall quantity of image information to be processed. Moreover, the preferred exemplary embodiment focus on detecting and tracing characteristic portion such as legs with feature in specific shapes instead of involving complexity in whole body of the target object such as pedestrian to judge his location and movement so that the processing and operation times can be substantially reduced.

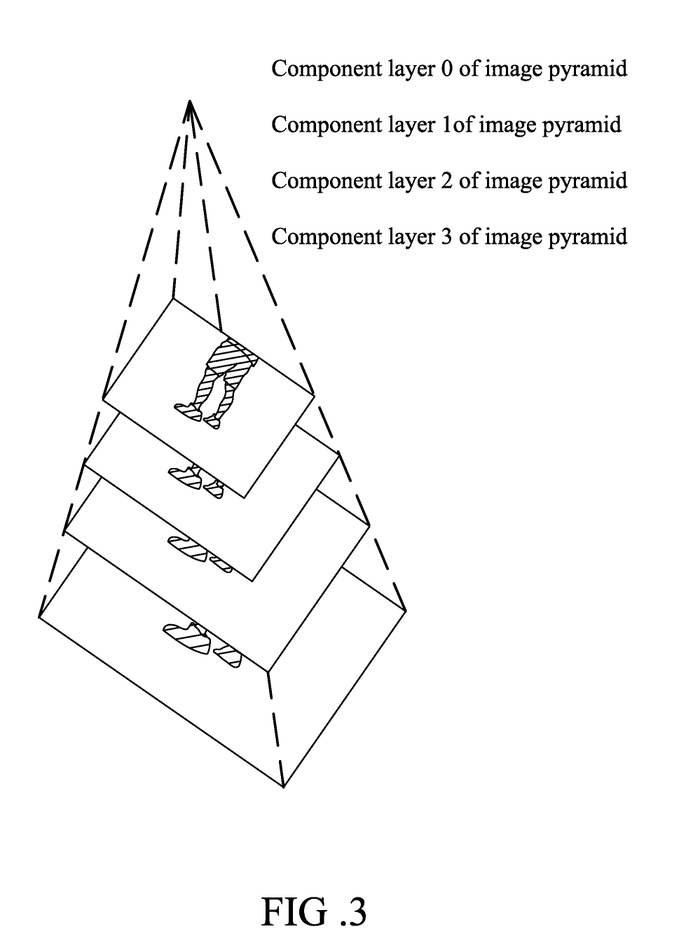

The image pyramids generation module (130) generates an image pyramid according to previously processed image. As shown in FIG. 3, the image pyramid, which is created here, includes a plurality of component layers or component levels of different scales and resolutions in regressive manner. In the image pyramid, the number of component layers as well as scale and resolution of each component layer can be adapted in accordance with the requirements of the feature complexity of the target object, processing and operational capability, real time detecting and tracing object etc. In the preferred exemplary embodiment, the image pyramids generation module (130) convert an original image in resolution of 80×60 processed by the image preprocessing module (120) into four component layers of different scales and resolutions in regressive manner.

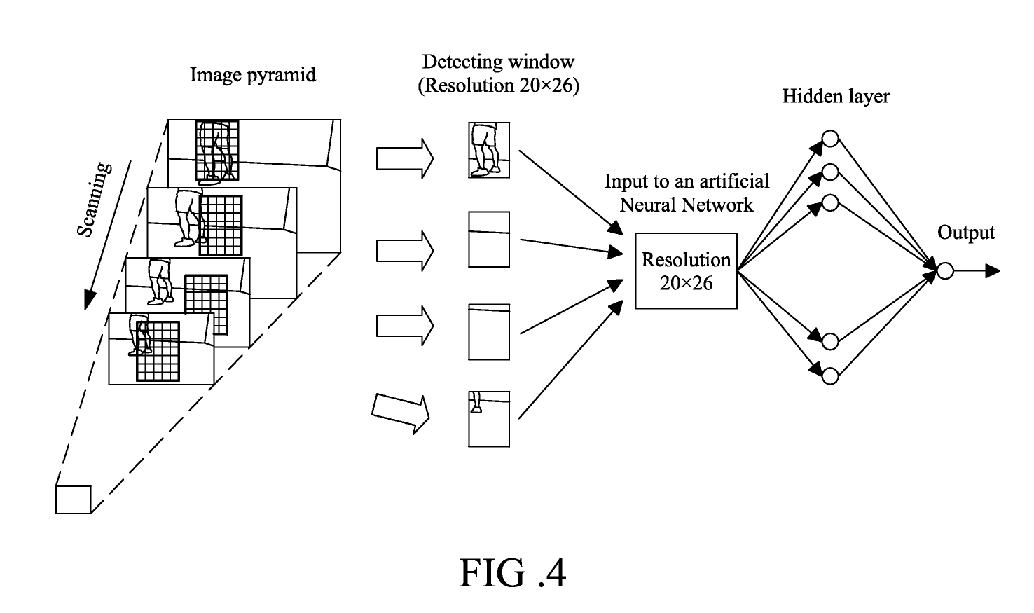

The detecting module (150) scans all the component layers of the image pyramid and performs a sorting operation in accordance with a feature information of an object, so as to generate a real time information for the object, which preferably includes a position information or position information and an object image model in the preferred exemplary embodiment so as to position the object in the environmental image. Moreover, as shown in FIG. 4, the detecting module (150) scans all the component layers of the image pyramid by means of a detecting window of preset dimension in resolution of 26×20 in the preferred exemplary embodiment. With such detecting window of preset dimension to scan objects of different dimensions in the image to be judged, by means of the adaptable scale and resolution in establishing the image pyramid, the dimension of each object can be selectively adapted to meet the preset dimension of the detecting window so as to facilitate scanning operation to the objects of different dimensions. Furthermore, the resolution of the processed image from the image pyramids generation module (130) is preferably greater than the preset resolution of the detecting window.

Besides, if required, each component layer of the image pyramid yielded by the image pyramids generation module (130) can be image-intensifying processed such as Gaussian filter to delete noise, bar chart equalization to increase the contrast degree for benefit to perform sorting operation by the detecting module (150). Other than foregoing component layer of the image pyramid, an image in specific component layer selectively acquired from the image pyramid with dimension as same as the preset dimension of the detecting window can also be image-intensifying processed similarly.

The feature information of an object provides the detecting module (150) adequate information to search each component layer of the image pyramid for judge whether there is any target object. For example, as shown in FIG. 4, the feature information of an object includes certain parameters such as number of the neuron and weighted values etc. in the hidden layer of an artificial Neural Network, which is trained by the training module (140) to perform sorting operation by the detecting module (150). Moreover, the image, which is acquired by the detecting window, is input to an artificial Neural Network for performing sorting operation with output value of “1” to denote the acquired image is object image, and output value of “0” to denote the acquired image is non-object image, respectively. Namely, the image acquired by the detecting window is mostly an object image if the output value of the artificial Neural Network is nearly 1 while the image acquired by the detecting window is mostly a non-object image if the output value of the artificial Neural Network is nearly 0.

The training module (140) creates previous feature information for all objects in accordance with plural object training samples and non-object training samples available, which are input into the training module (140) preferably via orderly image acquisition by the image accessing module (110), normalizing adaptation by the image preprocessing module (120) and image pyramids generation module (130) in the preferred exemplary embodiment. However, these training samples can also be obtained by other means other than foregoing method.

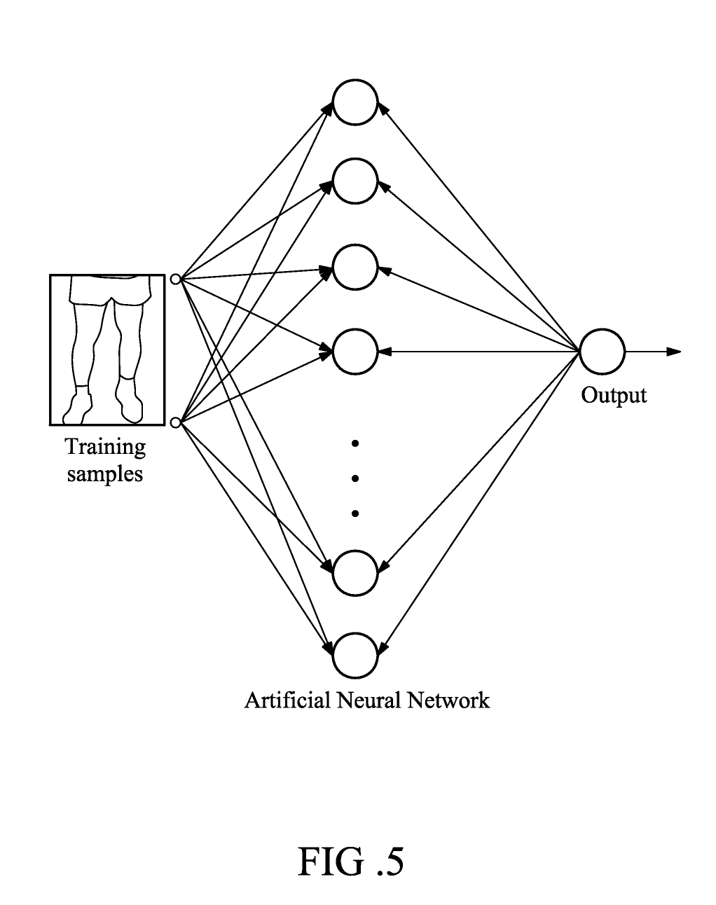

For a preferred exemplary embodiment as shown in FIG. 5, an artificial Back Propagation Neural Network (BPN) is employed in the training module (140) to perform training of sorting operation. The training algorithm of sorting operation includes following procedure: firstly, collect all object training samples and non-object training samples available in mass scale; secondly, perform normalizing adaptation on previous training samples into preset scale and resolution as same as those of previous detecting window; and finally, perform training of sorting operation on previous training samples by means of an artificial Neural Network with output value of “1” to denote the acquired image is object image, as well as output value of “0” to denote the acquired image is non-object image. As shown in FIG. 5, in performing training of sorting operation, a target image of one previous training sample is input into the artificial Neural Network to adjust parameters of number of the neuron and weighted values in the hidden layer of the artificial Neural Network to reach minimal error function in accordance with difference between the output value of the artificial Neural Network and a target output value. For a preferred exemplary embodiment, the related parameters such as number of the neuron and weighted values etc. in the hidden layer of the artificial Neural Network can be served as feature information of an object for performing sorting operation by the detecting module (150).

The tracing module (160), after the detecting module (150) detects the target object, generates a tracing information according to the position information of the target object in the image and the object image model established by the detecting module (150). For a preferred exemplary embodiment, the tracing module (160) can includes a particle filter to dynamically trace the position of the target object. Moreover, the position information of the target object in the image can be employed by the tracing module (160) for searching out a surrounding region of the position for the target object possibly appearing from subsequent images to be judged, and to confirm the moving direction of the target object by performing similarity comparison via object image model to search out one of most resemblance.

In the object tracing process, information such as movement, edge, color and the like can be used as feature for the similarity comparison. Moreover, the image used in the object tracing process can be an image directly acquired from the image accessing module (110) instead of an image processed from the image preprocessing module (120) to obtain extra information to facilitate the object tracing process and reduce possibility of mistake in judgment due to background images. For a preferred exemplary embodiment, the similarity measurement of the Bhattacharyya Coefficient can be employed as similarity comparison between the target object and candidate ambiance, wherein the target object denotes object to be detected while the candidate ambiance denotes surrounding images of the target object in the next image to be judged.

The tracing information, which is generated by the tracing module (160) after process and operation therein, can be simply used to trace the moving direction of the target object so as to avoid collision with a mobile apparatus such as a mobile robot, and to alert a warning indication in the event of possibility in collision if the target object moves towards the mobile apparatus. Naturally, all applications of the present invention are disclosed only for exemplary illustration, which are not intended for limiting the application scope of the present invention.

The moving module (170) traces a target object or bypasses an object according to required tracing information or tracing information generated by the tracing module (160). In practical situation, the moving module (170) in a floor-sweeping robot is required to bypass the object such as the legs of the humans, so as to avoid collision while the moving module (170) in a mobile robot of entertainment is required to trace a moving object such as ball. Moreover, the image accessing module (110) should be installed in the moving module (170) to move together with the moving module (170) for acquiring surrounding images in real time manner. For a preferred exemplary embodiment, if required, all foregoing modules can be installed in the moving module (170) to form an integral apparatus such as mobile robot with feature of real time detecting and tracing function in movable manner so that not only the structure of the integral apparatus but also the communication among all modules via wire or wireless connection are simplified.

Both of the training module (140) and detecting module (150) in the present invention can be installed in the moving module (170) in together manner so that a target image of one previous training sample is input into the artificial Neural Network to adjust parameters in the hidden layer of the artificial Neural Network. Both of the training module (140) and detecting module (150) can jointly use a common artificial Neural Network in a preferred exemplary embodiment so that the sorting operation on previous training samples can be performed simply by means of an artificial Neural Network with output value. Other than foregoing cases, both of the training module (140) and detecting module (150) in the present invention can also be disposed outside of the moving module (170) in separated manner. The feature information of an object, which is generated by the training module (140) and provided to the detecting module (150), can be remained constant without any change or further dynamically optimized by the detecting module (150).

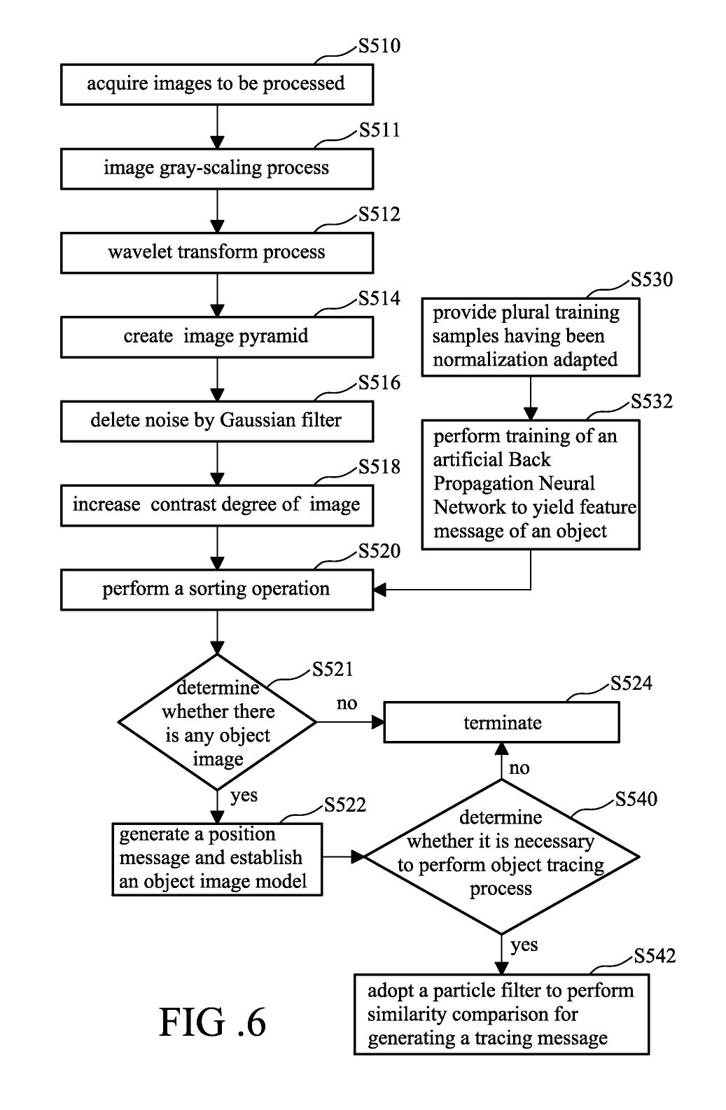

FIG. 6 is a schematic view of flowchart showing a preferred exemplary embodiment for the real time detecting and tracing system using computer vision in FIG. 1 of the present invention. As shown in FIG. 6, the processing procedure includes following steps in order manner.

Step S510: access and acquire images to be processed and judged from surrounding environment.

Step S511: perform an image gray-scaling process on previously processed images from step S510.

Step S512: perform a Haar wavelet transform process on previously processed images from step S511.

Step S514: create an image pyramid including plural component layers or component levels of different scales and resolutions in regressive manner from previously processed images of step S512.

Step S516: delete noise by a Gaussian filter on previously processed images from step S514 for preliminary image-intensification.

Step S518: increase the contrast degree for benefit to perform sorting operation by bar chart equalization on previously processed images from step S516 for further image-intensification.

Step S520: perform a sorting operation to judge whether the target object is an object image via scanning all the component layers or component levels of the image pyramid in accordance with a feature information of an object. As shown in FIG. 4, in a preferred exemplary embodiment, the feature information of an object come from a trained artificial Neural Network, particularly for one including certain parameters of number of the neuron and weighted values in the hidden layer thereof. Moreover, after performing sorting operation, the artificial Neural Network will generate an output value of nearly 1 or nearly 0 to individually denote the acquired image is object image and non-object image respectively.

As shown in FIG. 6, the processing procedure further includes following steps in order manner.

Step S530: in a training algorithm of sorting operation for an artificial Back Propagation Neural Network (BPN), perform normalizing adaptation on all object training samples and non-object training samples collected into preset scale and resolution as same as those of a detecting window.

Step S532: perform training of sorting operation, previous training samples are input into the artificial Neural Network to stepwise adjust parameters thereof to reach minimal error function via reducing difference between the output value of the artificial Neural Network and the target output value, so as to enhance the accuracy in judgment of the object image. After having finished training of sorting operation on all training samples, the parameters of the artificial Neural Network can be used in the step S520 as feature information of an object required in the sorting operation.

Step S521: determine whether there is any object image. The procedure is continuously routed to step S522 if result is true while the procedure is continuously routed to step S524 if result is false.

Step S522: generate a position information of the object in the image, and establish an object image model for tracing target object subsequently.

Step S524: stop the flow procedure immediately.

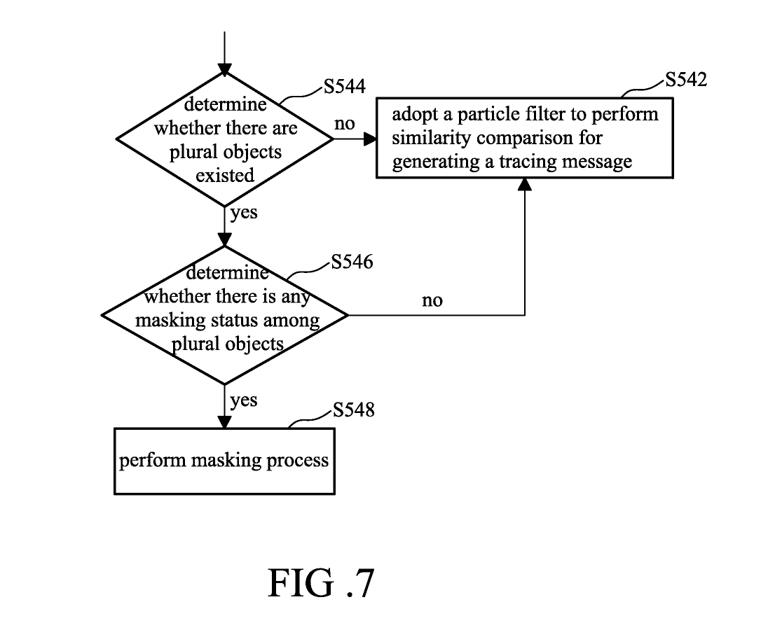

Step S540: determine whether it is necessary to perform object tracing process. The procedure is continuously routed to step S542 if result is true while the procedure is continuously routed to step S524 if result is false in a preferred exemplary embodiment for single object definitely as shown in FIG. 6. Another procedure should be continuously routed to step S544 if result is true while the procedure should be continuously routed to step S524 if result is false in a preferred exemplary embodiment for plural objects possibly as shown in FIG. 7.

Step S542: adopt a particle filter to perform similarity comparison between the target object and the candidate ambiance for generating a tracing information, in order to achieve the object of dynamically tracing the position of the target object. The target object includes the position information and the object image model established from step S522, and the acquired candidate ambiance includes surrounding images of the target object in the next image to be judged. For a preferred exemplary embodiment, the similarity measurement of the Bhattacharyya Coefficient can be employed as similarity comparison between the target object and candidate ambiance.

Step S524: stop the flow procedure immediately.

As shown in FIG. 6, the procedure is routed for a preferred exemplary embodiment with definite single object while the procedure is routed for a preferred exemplary embodiment with possible plural objects as shown in FIG. 7. As shown the S544 in FIG. 7, continuing and succeeding to the step S540 in FIG. 6. the procedure here determines whether there are plural objects.

Step S544: after determining whether it is necessary to perform object tracing process, determine whether there are plural objects existed in the image to be judged. The procedure is continuously routed to step S542 if there is a single object in the image, so that a particle filter is adopted to perform similarity comparison between the target object and the candidate ambiance for generating a tracing information.

The procedure is continuously routed to step S546 if there is plural objects in the image.

Step S546: determine whether there is any masking status among plural objects. The procedure is continuously routed back to step S542 if result is false while the procedure is continuously routed to step S548 if result is true.

Step S542: being similar to the process adopted in dealing with single object, adopt a particle filter to perform similarity comparison between each target object established from step S522 and each candidate ambiance in the next image to be judged, for generating a tracing information of each target object.

Step S548: perform object tracing process after having finished masking process with additional feature information of moving direction. Then, adopt a particle filter to perform similarity comparison between a target-object feature information established from step S522 with additional a moving-direction feature information established from step S548 and each candidate ambiance in the next image to be judged for generating a tracing information.

Finally, go back to step S540 for determining whether it is necessary to perform object tracing process.

The technology provided by foregoing preferred exemplary embodiments of the present invention can quickly detect and trace object(s) such as legs of pedestrian with feature profile particularly. Taking legs of pedestrian as example, the preferred exemplary embodiment focus on detecting and tracing characteristic portion of legs with feature in specific shapes instead of involving complexity in whole body of the pedestrian to judge his location and movement so that the processing and operation times can be substantially reduced. Because the heights of most current mobile robots in the market are usually lower than the normal height of the human being, the image contents acquired by these robots are confined to a certain height lower than the normal height of the human being as well. Therefore, the present invention especially applicable to mobile apparatus or this kind of mobile robots such as floor-sweeping robot that it can perform real time detecting and tracing function on surrounding objects to take suitably corresponding measures.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A real time detecting and tracing apparatus for an object, comprising:
an image accessing module for accessing and acquiring an image to be processed and judged;
an image preprocessing module for removing unnecessary information from the previously acquired image to generate a processed images;
an image pyramids generation module for generating an image pyramid having a plurality of component layers according to the previously processed image;
a detecting module for scanning all the component layers of the image pyramid in accordance with a feature information of the object to perform a sorting operation, so as to generate a real time information for the target object; and
a tracing module for generating a tracing information according to the previously yielded real time information.

2. The real time detecting and tracing apparatus of claim 1, further comprising a training module to create the feature information for the target object via an artificial Back Propagation Neural Network (BPN) in accordance with a plurality of training samples.

3. The real time detecting and tracing apparatus of claim 1, further comprising a moving module to trace or bypass the target object according to the tracing information.

4. The real time detecting and tracing apparatus of claim 1, wherein the tracing module comprises a particle filter to perform similarity comparison for at least a subsequent image to be judged to generate the tracing information according to the real time information, wherein the real time information comprises a position information of the target object and an object image model.

5. The real time detecting and tracing apparatus of claim 1, wherein the detecting module scans all the component layers of the image pyramid by means of a detecting window of preset dimension for performing the sorting operation to locate the target object in the image to be judged.

6. A real time detecting and tracing method for a target object, comprising following steps:
accessing and acquiring an image to be processed and judged;
removing unnecessary information from the previously acquired image to generate a processed images;
generating an image pyramid having a plurality of component layers according to the previously processed image;
scanning all the component layers of the image pyramid in accordance with a feature information of the target object to perform a sorting operation, so as to generate a real time information for the target object; and
generating a tracing information according to the previously yielded real time information if there is the target object in the image to be judged.

7. The real time detecting and tracing method of claim 6, wherein the feature information of the target object is created by an artificial Back Propagation Neural Network (BPN) in accordance with a plurality of training samples.

8. The real time detecting and tracing method of claim 6, further comprising a step by means of a moving module to trace or bypass the target object according to the tracing information.

9. The real time detecting and tracing method of claim 6, wherein the step of generating the tracing information is processed by performing similarity comparison for at least a subsequent image to be judged in accordance with the real time information, wherein the real time information comprises a position information of the target object and an object image model.

10. The real time detecting and tracing method of claim 6, wherein the step of scanning all the component layers of the image pyramid and performing the sorting operation is performed by means of a detecting window of preset dimension.
